(19) United States
(12) Patent Application Publication
(10) Pub. No.: US 2004/0230775 A1
(43) Pub. Date: Nov. 18, 2004

(54) Computer instructions for optimum performance of C-language string functions

(75) Inventors: Timothy J. Slegel, Staatsburg, NY (US); Fadi Y. Busaba, Poughkeepsie, NY (US); Christopher A. Krygowski, Lagrangeville, NY (US)

Correspondence Address: Lynn L. Augspurger, IBM Corporation, 2455 South Road, P386, Poughkeepsie, NY, 12601, US

(73) Assignee: International Business Machines Corporation, Armonk, NY (US)

(21) Appl. No.: 10/435,987

(22) Filed: May 12, 2003

(51) Int. Cl. G06F 9/44

(52) U.S. Cl. 712/223

(57) ABSTRACT

Several new computer instructions are shown which are used to improve the performance of C or C++ language string functions. The instruction simultaneously compare multiple byte in two registers with each other and with all zeros and indicates the results of the comparison in the condition code and in a register which indicates the leftmost byte that compared or miscompared. The instructions may be exposed at the computer system's instruction set level, or it may be used internally by microcode running on the computer.

### FIELD OF THE INVENTION

This invention relates to computer instruction set architecture. The invention particularly is directed to computer instructions for optimizing performance of C/C++ language string functions allowing a microcode/millicode implementation of these string functions as well as a general purpose instruction that could be used directly by a C compiler.

Trademarks: IBM® is a registered trademark of International Business Machines Corporation, Armonk, N.Y., U.S.A. S/390, Z900 and z990 and other product names may be registered trademarks or product names of International Business Machines Corporation or other companies.

### BACKGROUND

Before our invention, a number of computer instruction set architectures contained instructions specifically designed to be used by a C or C++ compiler to implement the string functions. The string functions include strlen( ), strstr( ), strcmp( ), and strchr( ), and also others. See, for example, the book “The C Programming Language” by Brian W. Kernighan and Dennis M. Ritchie published by Prentice Hall in 1988 for the definition of these functions.

Strings in the C or C++ language are always terminated with a byte of ‘00’x. There is no direct concept of the length of the string and it can only be determined by scanning the string of bytes for a byte of ‘00’x. Strings in C or C++ can be theoretically very long and are only limited to the amount of memory in the system.

A C or C++ language compiler, hereafter referred to as simply a “C compiler” translates these string functions into machine language instructions for a given instruction set architecture. Generally, CISC architectures have instructions designed to efficiently implement these string functions. The IBM zArchitecture provides the Search String (SRST), Compare Logical String (CLST), Compare Until Substring Equal (CUSE), Move String (MVST), and Compare Logical Character Long (CLCL). For more details see IBM Z/Architecture Principles of Operation, Publication SA22-7832-00, which is considered included here in its entirety. The Intel IA-32 architecture includes the instructions Move String (MOVS), Compare String (CMPS), Scan String (SCAS), Load String (LODS), and Store String (STOS). It also includes the Repeat prefixes (REP, REPE, REPZ, REPNE, REPNZ) for implicit looping once the length of a string is known. See the website http://www.x86.org/intel.doc/p2manuals.htm (published by Intel Corporation on the web and available at the time of filing of this application) for manual “Pentium II Processor Developer's Manual”) which is considered included here in its entirety. These instruction set instructions may be implemented entirely in hardware, entirely in microcode, or some combination of the two. Typically RISC architectures do not implement a rich set of string instructions, if they implement any at all. Therefore performance of string functions, in terms of the total number of instructions needed to implement them (not necessarily overall performance), is usually not very good.

The fact that there is no explicit length to a string leads to problems in an efficient implementation. For example, consider the strcmp( ) function. This function compares two strings to see if they are equal and returns a result which string is “less than” the other or 0 if they are equal. For each byte, an implementation needs to do two comparisons: the first comparing the bytes themselves and the second comparing if either byte is ‘00’x indicating the end of the string. This essentially makes it impossible for a compiler to generate code that processes more than a byte at a time with existing instructions.

Previously, IBM's U.S. Pat. No. 5,611,062 for “Specialized millicode instruction for string operations” by Charles Webb et al, published 1997-03-11 presented several instructions that Licensed Internal Code (commonly referred to as microcode, but as in the illustrated patent referred to as an IBM subset of microcode refered to as millicode, or “LIC”) could use to implement the C string instructions on the IBM zArchitecture systems. This patent should be considered to be included here in its entirety. This invention presented four instructions: Replicate Byte, Find Byte Equal, Find Byte Not Equal, and Compare String Bytes. Used together, these instructions could perform the following operations:

Perform three byte-sized comparisons at a time (compare two values in two registers, and also compare each of those two registers with a third register). The byte comparison is then repeated for all bytes in a register (typically 8 bytes).

Updates the condition code with the result of the comparison.

Sets a general register with the byte of the equality or inequality found in the comparison operation.

This invention although making string operations faster on the IBM zArchitecture had some limitations. The biggest is that there was too much to do so that all the operations could not be completed in a single machine cycle. In fact, on an IBM computer system that used this implementation, it took three machine cycles to perform the above operations. Another limitation is that it was designed for the full architecture exploitation of the instructions in the IBM zArchitecture. The zArchtecture allows the terminating byte to be specified in a register and does not necessarily have to be ‘00’x. Therefore, a Replicate Byte instruction was required at the beginning of the routine to set the ending character, which wasted additional cycles. This invention provides improved instructions.

### SUMMARY OF THE INVENTION

It is a feature of the invention that it provides an instruction set was architected such that it is not only suitable for use by millicode (“LIC” millicode is a form of Licensed Internal Code), and but also as general purpose instructions that could be used directly by a C compiler.

This invention disclosure describes two computer instructions that may be used to implement high-performance versions of the C/C++ language string instructions: strlen( ), strstr( ), strcmp( ) and strchr( ). These instructions may be made part of the normal computer's instruction set so that the C compiler can directly use them. In our implementation, they are actually hardware instructions that millicode uses to implement the zArchitecture instructions SRST, CLST, and CLCL. However, the implementation of these improvements allow direct C compiler implementation as well. Indeed, the concepts are general enough so that they could be exposed at the instruction set level so we describe the instruction set and individual instructions themselves.

This invention creates two new instructions that execute on the processor: we call them Compare Bytes (CB) and Compare Bytes Ending Assist (CBX). These instructions allow 8 bytes to be processed in each iteration of the loops handling the C language functions strlen( ), strstr( ), strcmp( ), and strchr( ) instead of the 1 byte per iteration that is possible without them.

Each of these instructions performs two or three slightly different functions under control of a mask field. It should be understood by one skilled in the art, that a given instruction set architecture may choose to implement only some subset of these functions or it may define unique instructions for the sub-functions instead of using a mask field as we have done.

The CB instructions performs two sub-functions controlled by a mask field in the instruction:

1. Compares the 8 individual bytes in two different registers for inequality and also simultaneously compares the bytes in these two registers to see if any byte is zero. This may be used for strstr( ) and strcmp( ).

2. Compares the 8 individual bytes in two different registers for equality. This may be used to implement strlen( ) and strchr( ) by making one of the registers all zeros for strlen( ) or replicating the comparison byte in all 8 bytes in a register for strchr( ).

The result of the comparisons above are determined in the condition code. It should be understood that in a 32-bit architecture, only 4 bytes would be used instead of the 8 bytes that would be typical in a 64-bit architecture.

The CB instruction is designed to be a high performance instruction that can be executed in a single machine cycle. The CBX instruction is a more complex instruction that returns more information, but could typically not be implemented so that it executes in a single machine cycle. Therefore, a program would execute CB instructions in its main iterative loop and at the end, a single CBX instruction to create the final results. The CBX instruction performs three sub-functions controlled by a mask field in the instruction:

1. The same function as number 1 in the CB instruction. In addition, the return code is set to explicitly state which of the conditions were met and a register is set to the value to indicate which byte the equality or inequality was found. This may be used to complete the execution of the strstr( ) and strcmp( ) functions.

2. The same function as number 2 in the CB instruction. In addition, a register is set to the value to indicate which byte equality was found. This may be used to complete the execution of the strlen( ) and strchr( ) functions.

3. The bytes of two registers are compared to determine if any bytes are not equal. A register is set to the value to indicate which byte inequality was found. This may be used by millicode to implement the IBM zArchitecture instruction CLCL. Note that there is no need for an analogous CB instruction sub-function here since a simple 8-byte compare instruction such as CLGR is sufficient to detect any inequality.

These and other improvements are set forth in the following detailed description. For a better understanding of the invention with advantages and features, refer to the description and to the drawings.

### DESCRIPTION OF THE DRAWINGS

FIG. 1 illustrates the format of the CB and CBX instructions.

FIG. 2 illustrates a typical implementation of the C string function strcmp( ) without the aid of the instructions presented in this invention.

FIG. 3 illustrates the function of the CBX instruction, sub-function 1.

FIG. 4 illustrates a typical implementation of the C string function strcmp( ) using the CB and CBX instruction for optimal performance.

FIG. 5, shows the preferred embodiment of a computer memory storage containing instructions in accordance with the preferred embodiment and data, as well as the mechanism for fetching, decoding and executing these instructions, either on a computer system employing these architected instructions or as used in emulation of our architected instructions.

Our detailed description explains the preferred embodiments of our invention, together with advantages and features, by way of example with reference to the drawings.

### DETAILED DESCRIPTION OF THE INVENTION

This section gives more explicit details on our implementation of the CB and CBX instruction. It should be understood by one skilled in the art that these details can be modified to suit a different instruction set architecture or microcode (or millicode) implementation.

The CB and CBX instructions are optimized for the C string application only; the ending byte must be a character of ‘00’x. When implementing the zArchitecture string functions if a different ending character is specified, then a slow byte at a time implementation may be used since this is seldom actually used and is not performance critical.

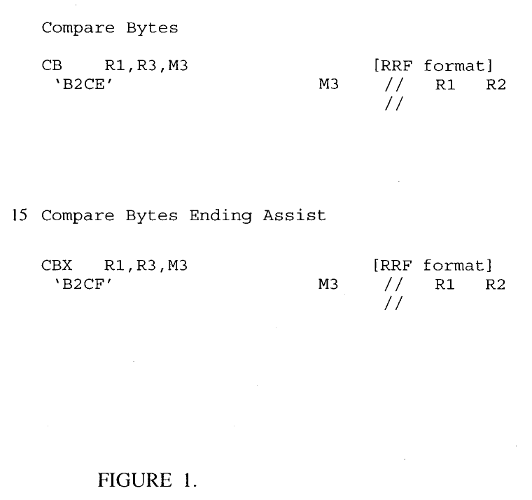

FIG. 1 illustrates the format of the CB and CBX instructions. Note that both instructions contain 3 fields in addition to the opcode: 1) a register field R1 for one of the values to be compared, 2) a register field R2 for the other value to be compared, and 3) a mask field M3 containing the sub-function to be performed by the instruction.

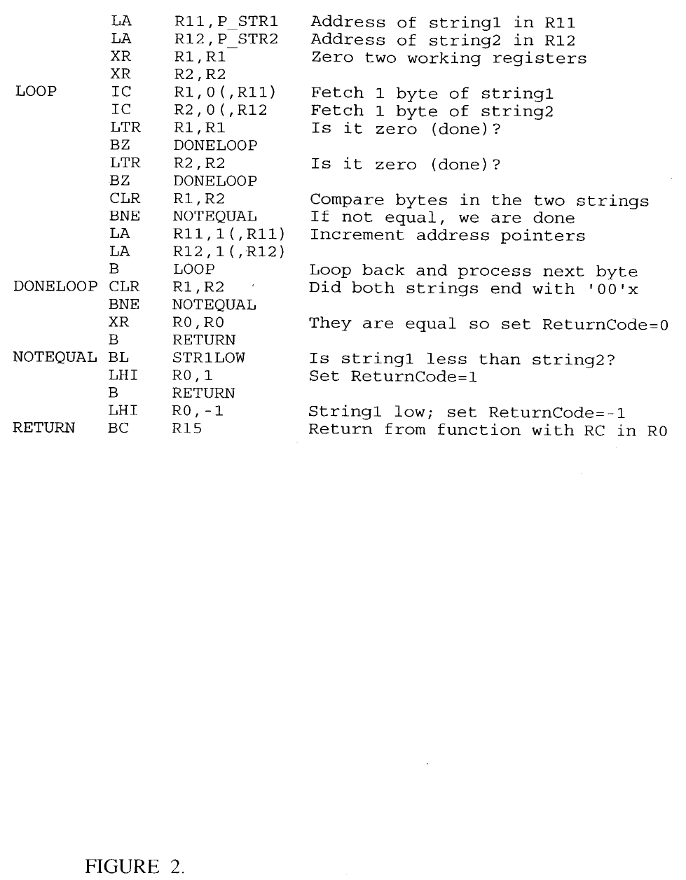

FIG. 2 shows a typical implementation of how a C compiler or assembler program might implement the C string function strcmp( ) without the aid of the instructions presented in this invention. This is written in IBM zArchitecture assembly language but it should be understood that a similar routine, illustrating the same features, could be written in an computer's instruction set assembly language. Note that this is a somewhat simplified version of the strcmp( ) function to illustrate the behavior applicable to this invention. A more sophisticated routine would be a bit more efficient, however the basic problem is still there: the code needs to process just one byte at a time. Similar problems exist for the strlen( ) and strstr( ) functions.

The CB instruction's two sub-functions are defined as follows:

1. When the mask field indicates sub-function number 1, the comparisons performed check for byte inequality between registers R1 and R2, and for byte equality between register R1 and a 64-bit value of all zeros, or between register R2 and a 64-bit value of all zeros. The condition code is set to 3 to indicate if any of these conditions was met and zero otherwise. If multiple conditions are satisfied, the condition code is still set to a value of 3.

2. When the mask field indicates sub-function number 2 the comparison performed checks for byte equality between registers R1 and R2. The condition code is set to a value of 3 if any corresponding bytes are equal and set to a value of 0 otherwise.

The CBX instruction's three sub-functions are defined as follows:

1. When the mask field indicates sub-function number 1, three comparisons are performed. The comparisons formed check for byte inequality between registers R1 and R2, and for byte equality between register R1 and a 64-bit value of all zeros, or between register R2 and a 64-bit value of all zeros. The condition code is set to indicate which (if any) of these conditions was met and its value is as specified later. Bits 61:63 of register number 0 are set to the byte position of the first byte to satisfy any condition, provided that at least one condition was met in at least one byte. Bits 0:60 of register 0 are set to zeros.

2. When the mask field indicates sub-function number 2, one comparison is performed. The comparison checks for byte equality between registers R1 and R2. The condition code is set to a value of 3 if any corresponding bytes are equal and 0 otherwise. Bits 61:63 of millicode register number 0 are set to the byte position of the leftmost byte to satisfy the equality. Bits 0:60 of register 0 are set to zeros.

3. When the mask field indicates sub-function 3, one comparison is performed. The comparison performed checks for byte inequality between registers R1 and R2. The condition code is set to a value of 3 if any corresponding bytes are not equal and 0 otherwise. Bits 61:63 of register number 0 are set to the byte position of the leftmost byte to satisfy the inequality. Bits 0:60 of register 0 are set to zeros.

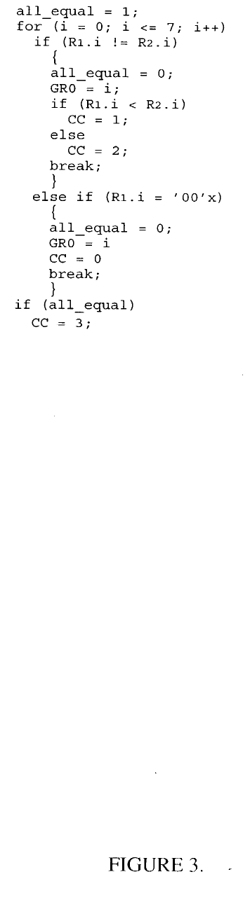

The CBX instruction, sub-function 1, is somewhat complex and the setting of the condition code needs further elaboration. FIG. 3 shows the algorithm for the function performed in pseudo-code. [Is this better shown in a flowchart?] The notation R1.i means the “i-th” byte of register R1.

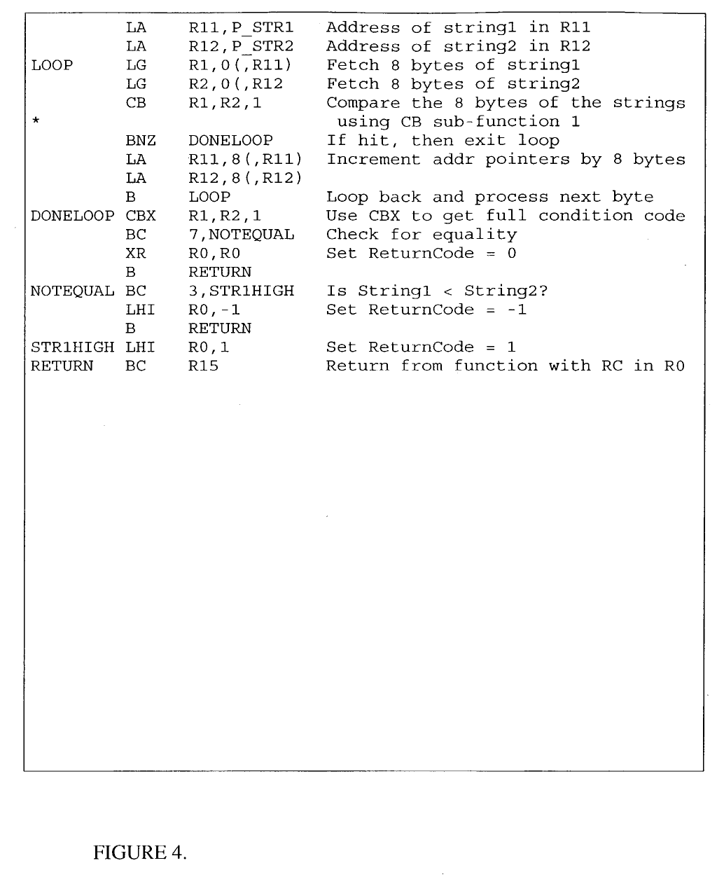

FIG. 4 shows an example of IBM zArchitecture assembler code implementing the same strcmp( ) function as in FIG. 1, except now it exploits the CB and CBX instructions contained in this invention. It should be observed that the main loop processes 8 bytes per iteration, plus uses several fewer instructions in each iteration as opposed to the 1 byte per iteration in the earlier example without using CB and CBX. Therefore, an implementation is typically many times faster than an implementation not using CB and CBX. It should be obvious how CB and CBX can be similarly used to implement strlen( ), strstr( ), and strchr( ).

Here we should note that execution can be performed directly or by emulation. In a commercial implementation of the invention it may be performed in a computer system having specific computer architected instruction formats where the instructions are used by programmers, usually today “C” programmers. These instruction formats stored in the storage medium may be executed natively in a Z/Architecture IBM Server, or alternatively in machines executing other architectures. They can be emulated in the existing and in future IBM mainframe servers and on other machines of IBM (e.g. pSeries Servers and xSeries Servers). They can be executed in machines running Limum on a wide variety of machines using hardware manufactured by IBM, Intel, AMD, Sun Microsystems and others. Besides execution on that hardware under a Z/Architecture, Linux can be used as well as machines which use emulation by Hercules, UMX, FXI or Platform Solutions, where generally execution is in an emulation mode. In emulation mode the specific instruction being emulated is decoded, and a subroutine built to implement the individual instruction, as in a “C” subroutine or driver, or some other method of providing a driver for the specific hardware as is within the skill of those in the art after understanding the description of the preferred embodiment. Various software and hardware emulation patents including, but not limited to U.S. Pat. No. 5,551,013 for a “Multiprocessor for hardware emulation” of Beausoleil et al., and U.S. Pat. No. 6,009,261: Preprocessing of stored target routines for emulating incompatible instructions on a target processor” of Scalzi et al; and U.S. Pat. No. 5,574,873: Decoding guest instruction to directly access emulation routines that emulate the guest instructions, of Davidian et al; U.S. Pat. No. 6,308,255: Symmetrical multiprocessing bus and chipset used for coprocessor support allowing non-native code to run in a system, of Gorishek et al; and U.S. Pat. No. 6,463,582: Dynamic optimizing object code translator for architecture emulation and dynamic optimizing object code translation method of Lethin et al; and U.S. Pat. No. 5,790,825: Method for emulating guest instructions on a host computer through dynamic recompilation of host instructions of Eric Traut; and many others, illustrate the a variety of known ways to achieve emulation of an instruction format architected for a different machine for a target machine available to those skilled in the art, as well as those commercial software techniques used by those referenced above.

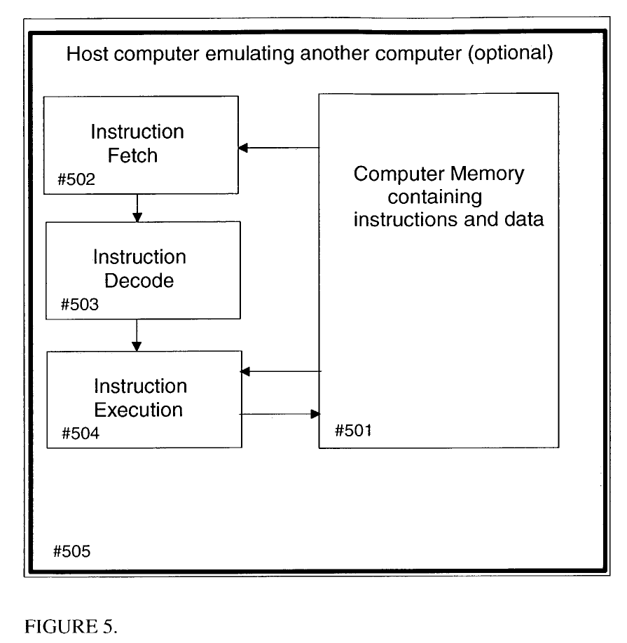

As illustrated by FIG. 5 these instructions are executed in hardware by a processor or by emulation of said instruction set by software executing on a computer having a different native instruction set.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

We claim:

1. A computer instruction performing a plurality of byte-wise comparisons between the contents of two registers where said comparisons include comparing for inequality between bytes in said registers; comparing the first register for equality with bytes of zeros; comparing the second register for equality with bytes of zeros; and setting a condition code to some value to indicate if any one or more of these conditions were met and setting said condition code to some other value if none of the conditions were met.

2. The computer instruction in claim 1 wherein said computer instruction is part of the computer's instruction set architecture and is directly usable by a compiler or other program, or the computer instruction is such that it is only usable by microcode running on said computer.

3. The computer instruction in claim 1 wherein the instruction is used as a general purpose instruction that is used by a C Compiler.

4. The computer instruction in claim 1 wherein the instruction is architected such that it is not only suitable for use by microcode and millicode, and also as a general purpose instruction that could be used by a C compiler, and directly or by emulation.

5. A computer instruction performing a plurality of byte-wise comparisons between the contents of two registers where said comparisons include comparing for equality between bytes in said registers and setting the condition code to some value if any pair of bytes being compared has equality and setting said-condition code to some other value if no bytes have equality.

6. The computer instruction in claim 5 where said computer instruction is part of the computer's instruction set architecture and is directly usable by a compiler or other program, or the computer instruction is such that it is only usable by microcode running on said computer.

7. The computer instruction in claim 5 wherein the instruction is used as a general purpose instruction that is used by a C Compiler.

8. The computer instruction in claim 5 wherein the instruction is architected such that it is not only suitable for use by microcode and millicode, and also as a general purpose instruction that could be used by a C compiler, and directly or by emulation.

9. A computer instruction performing a plurality of byte-wise comparisons between the contents of two registers where said comparisons include comparing for inequality between bytes in said registers; comparing the first register for equality with bytes of zeros; comparing the second register for equality with bytes of zeros; setting a condition code to different values to indicate which, if any, of these conditions are met, and to some other value if none are met; and setting the value in a register, or a field in said register, to indicate which byte of the plurality of bytes being compared was the leftmost byte to satisfy any condition.

10. The computer instruction in claim 9 wherein the instruction is used as a general purpose instruction that is used by a C Compiler.

11. The computer instruction in claim 9 wherein the instruction is architected such that it is not only suitable for use by microcode and millicode, and also as a general purpose instruction that could be used by a C compiler, and directly or by emulation.

12. The computer instruction in claim 9 where said computer instruction is part of the computer's instruction set architecture and is directly usable by a compiler or other program, or the computers instruction is such that it is only usable by microcode running on said computer.

13. The computer instruction in claim 9 where the register indicating which was the leftmost byte meeting the comparison is set to a value of zero if no comparisons were satisfied or the register may be unpredictable.

14. A computer instruction performing a plurality of byte-wise comparisons between the contents of two registers where said comparisons include comparing for equality between bytes in said registers; setting a condition code to indicate the result of the comparison; and setting the value in a register, or a field in said register, to indicate which byte of the plurality of bytes being compared was the leftmost byte to satisfy the equality comparison.

15. The computer instruction in claim 14 wherein the instruction is used as a general purpose instruction that is used by a C Compiler.

16. The computer instruction in claim 14 where said computer instruction is part of the computer's instruction set architecture and is directly usable by a compiler or other program, or the computers instruction is such that it is only usable by microcode running on said computer.

17. The computer instruction in claim 14 wherein the instruction is architected such that it is not only suitable for use by microcode and millicode, and also as a general purpose instruction that could be used by a C compiler, and directly or by emulation.

18. The computer instruction in claim 14 where the register indicating which was the leftmost byte meeting the comparison is set to a value of zero if no comparisons were satisfied or the register may be unpredictable.

19. A computer instruction performing a plurality of byte-wise comparisons between the contents of two registers where said comparisons include comparing for inequality between bytes in said registers; setting a condition code to indicate the result of the comparison; and setting the value in a register, or a field in said register, to indicate which byte of the plurality of bytes being compared was the leftmost byte to satisfy the inequality comparison.

20. The computer instruction in claim 19 where said computer instruction is part of the computer's instruction set architecture and is directly usable by a compiler or other program, or the computer's instruction is such that it is only usable by microcode running on said computer.

21. The computer instruction in claim 19 wherein the instruction is used as a general purpose instruction that is used by a C Compiler.

22. The computer instruction in claim 19 wherein the instruction is architected such that it is not only suitable for use by microcode and millicode, and also as a general purpose instruction that could be used by a C compiler, and directly or by emulation.

23. The computer instruction in claim 19 where the register indicating which was the leftmost byte meeting the comparison is set to a value of zero if no comparisons were satisfied or the register may be unpredictable.

24. A computer system, comprising a computer using an instruction adapted to be fetched for execution for performing directly or by emulation a plurality of byte-wise comparisons between the contents of two registers where said comparisons include comparing for inequality between bytes in said registers; comparing the first register for equality with bytes of zeros; comparing the second register for equality with bytes of zeros; and setting a condition code to some value to indicate if any one or more of these conditions were met and setting said condition code to some other value if none of the conditions were met.

25. A computer media containing an instruction for performing directly or by emulation a plurality of byte-wise comparisons between the contents of two registers where said comparisons include comparing for inequality between bytes in said registers; comparing the first register for equality with bytes of zeros; comparing the second register for equality with bytes of zeros; and setting a condition code to some value to indicate if any one or more of these conditions were met and setting said condition code to some other value if none of the conditions were met.

26. A computer system, comprising a computer using an instruction adapted to be fetched for execution for performing directly or by emulation a plurality of byte-wise comparisons between the contents of two registers where said comparisons include comparing for equality between bytes in said registers and setting the condition code to some value if any pair of bytes being compared has equality and setting said condition code to some other value if no bytes have equality.

27. A computer media containing an instruction for performing directly or by emulation a plurality of byte-wise comparisons between the contents of two registers where said comparisons include comparing for equality between bytes in said registers and setting the condition code to some value if any pair of bytes being compared has equality and setting said condition code to some other value if no bytes have equality.

28. A computer system, comprising a computer using an instruction adapted to be fetched for execution for performing directly or by emulation a plurality of byte-wise comparisons between the contents of two registers where said comparisons include comparing for inequality between bytes in said registers; comparing the first register for equality with bytes of zeros; comparing the second register for equality with bytes of zeros; setting a condition code to different values to indicate which, if any, of these conditions are met, and to some other value if none are met; and setting the value in a register, or a field in said register, to indicate which byte of the plurality of bytes being compared was the leftmost byte to satisfy any condition.

29. A computer media containing an instruction for performing directly or by emulation a plurality of byte-wise comparisons between the contents of two registers where said comparisons include comparing for inequality between bytes in said registers; comparing the first register for equality with bytes of zeros; comparing the second register for equality with bytes of zeros; setting a condition code to different values to indicate which, if any, of these conditions are met, and to some other value if none are met; and setting the value in a register, or a field in said register, to indicate which byte of the plurality of bytes being compared was the leftmost byte to satisfy any condition.

30. A computer system, comprising a computer using an instruction adapted to be fetched for execution for performing directly or by emulation a plurality of byte-wise comparisons between the contents of two registers where said comparisons include comparing for equality between bytes in said registers; setting a condition code to indicate the result of the comparison; and setting the value in a register, or a field in said register, to indicate which byte of the plurality of bytes being compared was the leftmost byte to satisfy the equality comparison.

31. A computer media containing an instruction for performing directly or by emulation a plurality of byte-wise comparisons between the contents of two registers where said comparisons include comparing for equality between bytes in said registers; setting a condition code to indicate the result of the comparison; and setting the value in a register, or a field in said register, to indicate which byte of the plurality of bytes being compared was the leftmost byte to satisfy the equality comparison.

32. A computer system, comprising a computer using an instruction adapted to be fetched for execution for performing directly or by emulation a plurality of byte-wise comparisons between the contents of two registers where said comparisons include comparing for inequality between bytes in said registers; setting a condition code to indicate the result of the comparison; and setting the value in a register, or a field in said register, to indicate which byte of the plurality of bytes being compared was the leftmost byte to satisfy the inequality comparison.

33. A computer media containing an instruction for performing directly or by emulation a plurality of byte-wise comparisons between the contents of two registers where said comparisons include comparing for inequality between bytes in said registers; setting a condition code to indicate the result of the comparison; and setting the value in a register, or a field in said register, to indicate which byte of the plurality of bytes being compared was the leftmost byte to satisfy the inequality comparison.
